(19) United States
(12) Patent Application Publication
(10) Pub. No.: US 2016/0360069 A1
(43) Pub. Date: Dec. 8, 2016

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Akira Ishikawa, Tokyo (JP)

(21) Appl. No.: 15/164,111

(22) Filed: May 25, 2016

(30) Foreign Application Priority Data
Jun. 4, 2015 (JP) 2015-114159

(51) Int. Cl. H04N 1/44; G06K 9/00; H04N 1/32; H04N 1/00

(52) U.S. Cl. CPC H04N 1/4413; H04N 1/00408; H04N 1/00122; H04N 1/00228; G06K 9/00456; H04N 1/32101; H04N 2201/0094; G06K 2209/01

(57) ABSTRACT

An information processing apparatus obtains a list of transmission destinations that can use document data in relation to a document feature indicated by the document data, which is processed in accordance with an instruction of an authenticated user, from a document feature management server using content of the document and information of the authenticated user, and displays it on an operation unit.

### BACKGROUND OF THE INVENTION

Field of the Invention

The present invention relates to an information processing apparatus that handles digital documents, a method of controlling the same and a storage medium.

Description of the Related Art

With the development of office devices such as PCs and multi-function peripherals, study documents, investigation documents, and proposal documents are often handled as digitized documents in job sites for intellectual production such as offices in which, for example, new technological proposals, new enterprise proposals and the like are made. If the organization is of a small scale, it is easy to understand who performed a study and in what kind of area it is related to, but in the case of a large scale organization, it is difficult to understand exhaustively the content of the studies of all members. There is a problem in that if the content of studies is not shared, waste such as when the same study is duplicated in the same organization occurs. A function has been proposed in which in a case where documents used in an organization or features of documents are managed in consolidation on a server, the features of the documents and the usage history are analyzed automatically, and notification is made when similar documents are handled. For example, in Japanese Patent Laid-Open No 2007-76008, a function that, at a time of document usage, proposes a document that is often used simultaneously, as in a recommendation function in a generic shopping site has been disclosed.

However, there is a problem as is recited below in the foregoing conventional technique. In the foregoing conventional technique, it is difficult to make a suitable proposal to a person who performs a study because while it is possible to propose other documents to a user of a document in accordance with the content of a study, it is not possible to know information of the person who performs the study, or of other people who perform studies. For example, if intellectual exchange is an objective, it is difficult to propose a personal exchange such as a cooperation on a study if only the content of the study documents is known. Also, while with office documents there are many things that require confidentiality management that considers fine authorization levels, there is the risk of a confidentiality leak if the form is such that the proposals of documents are made automatically in accordance with the content of the study, and so this is not practical.

### SUMMARY OF THE INVENTION

The present invention enables realization of a mechanism for presenting candidates that can use a document when that document is processed while reducing the risk of a confidentiality leak.

One aspect of the present invention provides an information processing apparatus comprising: an execution unit configured to execute processing relating to document data in accordance with an instruction of a user; an obtaining unit configured to obtain transmission destinations relating to a document feature indicated by the document data processed by the execution unit; and a display unit configured to display to enable selection of the transmission destinations obtained by the obtaining unit.

Another aspect of the present invention provides a method of controlling an information processing apparatus, the method comprising:

executing processing relating to document data in accordance with an instruction of a user; obtaining transmission destinations relating to a document feature indicated by the processed document data; and displaying to enable selection of the obtained transmission destinations.

Still another aspect of the present invention provides a non-transitory computer-readable storage medium storing a computer program for causing a computer to execute each step in a method of controlling an information processing apparatus, the method comprising: executing processing relating to document data in accordance with an instruction of a user; obtaining transmission destinations relating to a document feature indicated by the processed document data; and displaying to enable selection of the, obtained transmission destinations.

Further features of the present invention will be apparent from the following description of exemplary embodiments with reference to the attached drawings.

### BRIEF DESCRIPTION OF THE DRAWINGS

FIG. 1 is a block diagram illustrating an embodiment of an MFP and a document feature management server according to the present invention.

FIG. 2 is an internal configuration diagram of a controller unit of the MFP.

FIG. 3 is an internal configuration diagram of a controller unit of the document feature management server.

FIG. 4 is a view for illustrating a screen displayed on an operation unit of the MFP.

FIGS. 5A and 5B are flowcharts for implementing processing on the side of the MFP of the present invention.

FIG. 6 is a flowchart for implementing processing on the side of the document feature management server of the present invention.

FIG. 7 is a block diagram illustrating an embodiment of a PC and a document feature management server according to the present invention.

FIG. 8 is an internal configuration diagram of a controller unit of the PC.

FIG. 9 is a view for illustrating a screen displayed on an operation unit of the PC.

FIG. 10 is a flowchart for implementing processing on the side of the PC of the present invention.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<System Configuration>

Below, explanation will be given for a first embodiment of the present invention. Here explanation is given of an embodiment for an example of a cooperation between a document feature management server 110, and a multi-function peripheral (MFP) 100 which is an information processing apparatus; however, the present invention is a technique that can be applied to an information processing apparatuses other than an MFP. Also, explanation is given of an embodiment for an example of application in an office, but the present invention is a technique that can be applied to a system on the Internet of any scale.

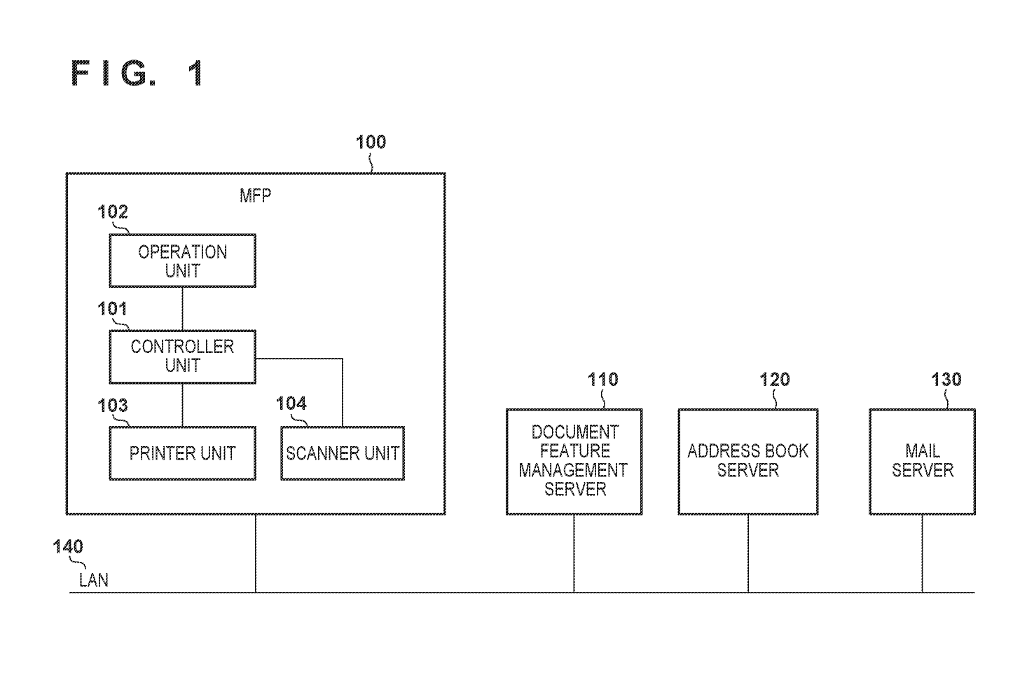

Firstly, with reference to FIG. 1, explanation is given for a system configuration including the MFP 100, the document feature management server 110, an address book server 120, and a mail server 130 according to the present invention. Note that the form of the system and the number of apparatuses included therein which are explained here are only one example, and are not intended to limit the present invention; the scope at which the present invention can be applied may be varied.

A system according to the embodiment includes the MFP 100, the document feature management server 110, the address book server 120, and the mail server 130, and each of these apparatuses is connected communicably by a LAN (Local Area Network) 140. The MFP 100 which is an information processing apparatus (image processing apparatus) is provided with a controller unit 101, an operation unit 102, a printer unit 103 and a scanner unit 104.

The operation unit 102 is a user interface for performing input/output with a user. The printer unit 103 outputs electronic data to paper media. The scanner unit 104 reads in paper media and converts it into electronic data. The operation unit 102, the printer unit 103 and the scanner unit 104 are connected to the controller unit 101, and MFP functions are realized in accordance with control of the controller unit 101.

The document feature management server 110 receives OCR (Optical Character Recognition) data of a document and a user ID from the MFP 100 via the LAN 140, and replies with a list of users having interest in similar documents. In other words, the document feature management server 110 manages parameters indicating features of a document and users related to the features in association, and in response to a query from the MFP 100 which is an information processing apparatus, generates and responds with a list of users (candidates (that is, a transmission destination)) having interest in the document. The address hook server 120 is a server that can register and reference user address information notified from another apparatus via the LAN 140. In this embodiment, a case in which the server is such that an LDAP (Lightweight Directory Access Protocol) implementation operates is assumed. The mail server 130 is a server in which mail transmissions from other apparatuses are received via the LAN 140, and, as an example in this embodiment, is a server in which an SMTP (Simple Mail Transfer Protocol) implementation operates.

<MFP Control Configuration>

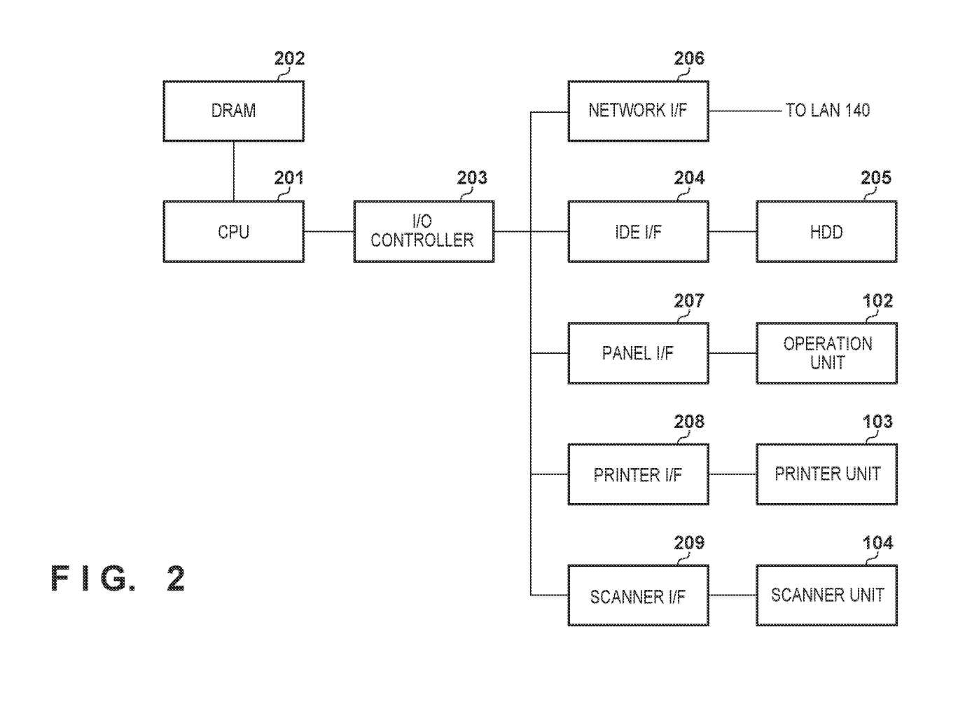

Next, with reference to FIG. 2, explanation is given for a detailed control configuration of the controller unit 101 of the MFP 100. The controller unit 101 is provided with a CPU 201, a DRAM 202, an I/O controller 203, and an IDE (Integrated Device Electronics) I/F 204. Also, the controller unit 101 is provided with an HDD 205, a network I/F 206, a panel I/F 207, a printer I/F 208 and a scanner I/F 209.

The CPU 201 performs primary calculation processing in the controller unit 101. The CPU 201 is connected with the DRAM 202 via a bus. The DRAM 202 is used by the CPU 201 as a work memory for temporarily arranging data to be processed, and program data describing commands for calculation by a process of the CPU: 201 calculating. The CPU 201 is connected with the I/O controller 203 via a bus. The I/O controller 203 performs input/output with respect to various devices in accordance with instructions of the CPU 201.

The IDE I/F 204 is connected to the I/O controller 203, and the HDD 205 is connected to the IDE I/7 204. The CPU 201 uses the HDD 205 to persistently store programs for realizing functions of the MFP 100, and document data that is read. The network I/F 206 is connected to the I/O controller 203, and the CPU 201 realizes communication on the LAN 140 via the network I/F 206. The panel I/F 207 is connected to the I/O controller 203, and the CPU 201 realizes input/output with respect to a user in relation to the operation unit 102 via the panel I/F 207. The printer I/F 208 is connected to the I/O controller 203, and the CPU 201 realizes paper media output processing that uses the printer unit 103 via the printer I/F 208. The scanner I/F 209 is connected to the I/O controller 203, and the CPU 201 realizes original read processing that uses the scanner unit 104 via the scanner I/F 209.

Here explanation is given for operation in a case where a copy function (copy processing) is implemented. Firstly, the CPU 201 reads program data from the HDD 205 via the IDE I/F 204 into the DRAM 202, The CPU 201 detects a copy instruction from a user with respect to the operation unit 102 via the panel I/F 207 in accordance with the program read into the DRAM 202. The CPU 201 receives an original from the scanner unit 104 via the scanner I/F 209 as electronic data when a copy instruction is detected, and stores the electronic data in the DRAM 202. The CPU 201 performs color conversion processing which is suited to output on the image data stored in the DRAM 202. The CPU 201 transfers the image data stored in the DRAM 202 to the printer unit 103 via the printer I/F 208, to perform processing for outputting to paper media.

Next, explanation is given for operation in a case where a scan transmission function (scan processing) is implemented. Firstly, the CPU 201 reads program data from the HDD 205 via the I/F 204 into the DRAM 202. The CPU 201 detects a scan transmission instruction from a user with respect to the operation unit 102 via the panel I/F 207 in accordance with the program read into the DRAM 202. The CPU 201 receives an original from the scanner unit 104 via the scanner I/F 209 as electronic data when a scan transmission instruction is detected, and stores the electronic data in the DRAM 202. The CPU 201 performs, on the image data stored in the DRAM 202, color conversion processing which is suitable for outputting. The CPU 201, having attached the image data stored in the DRAM 202 to data of a mail format, transmits to the mail server 130 via the network I/F 206.

Next, explanation is given for an operation in a case where PDL printing is performed. Firstly, the CPU 201 reads program data from the HDD 205 via the IDE I/F 204 into the DRAM 202, and detects a print instruction via the network I/F 206 in accordance with the program read into the DRAM 202. The CPU 201 receives print data via the network I/F 206 when a PDL transmission instruction is detected, and saves the print data in the HDD 205 via the IDE I/F 204. The CPU 201 loads, the print data saved in the HDD 205 into the DRAM 202 as image data when the saving of the print data completes. The CPU 201 performs color conversion processing, suitable for outputting, on the image data stored in the DRAM 202. The CPU 201 transfers the image data stored in the DRAM 202 to the printer unit 103 via the printer I/F 208, and performs processing for outputting to paper media.

<Document Feature Management Server Control Configuration>

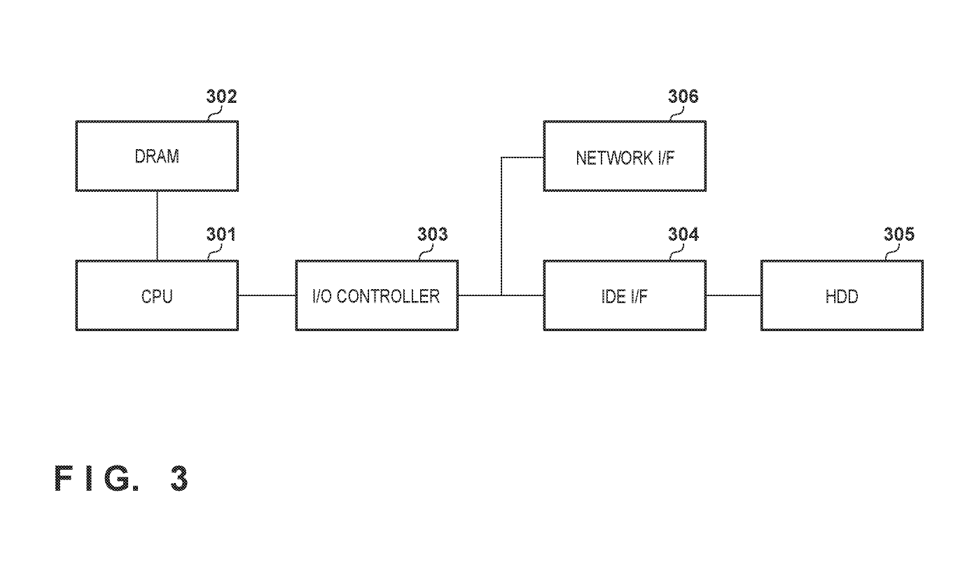

Next, with reference to FIG. 3, explanation is given for a detailed control configuration of the controller unit of the document feature management server 110. The controller unit of the document feature management server 110 is provided with a CPU 301, a DRAM 302, an I/O controller 303, an IDE I/F 304, an HDD 305, and a network I/F 306.

The CPU 301 performs primary calculation processing in the controller unit. The CPU 301 is connected with the DRAM 302 via a bus. The DRAM 302 is used by the CPU 301 as a work memory for temporarily arranging data to be processed, and program data describing commands for calculation by a process of the CPU 301 calculating. The CPU 301 is connected with the I/O controller 303 via a bus. The I/O controller 303 performs input/output with respect to various devices in accordance with instructions of the CPU 301. The IDE I/F 304 is connected to the I/O controller 303, and the HDD 305 is connected to the IDE I/F 304. The CPU 301 uses the HDD 305 to persistently store programs for realizing functions of the document feature management server 110, as well as received document feature information and user information. The network I/F 306 is connected to the I/O controller 303, and the CPU 301 realizes communication on the LAN 140 via the network I/F 306.

<MFP Processing Procedure>

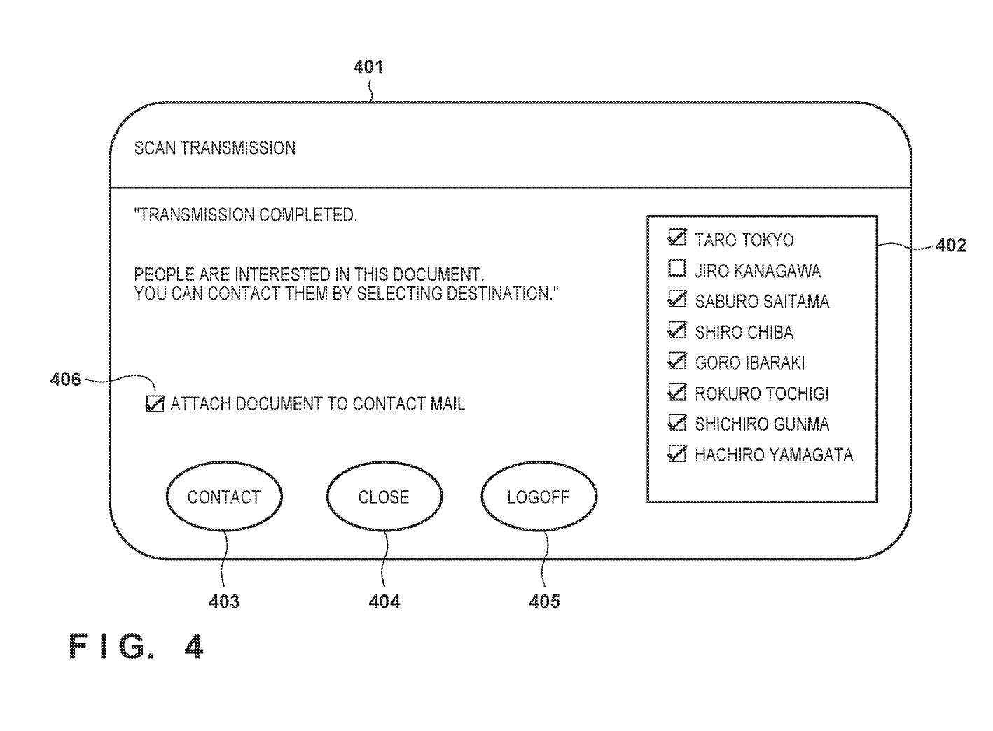

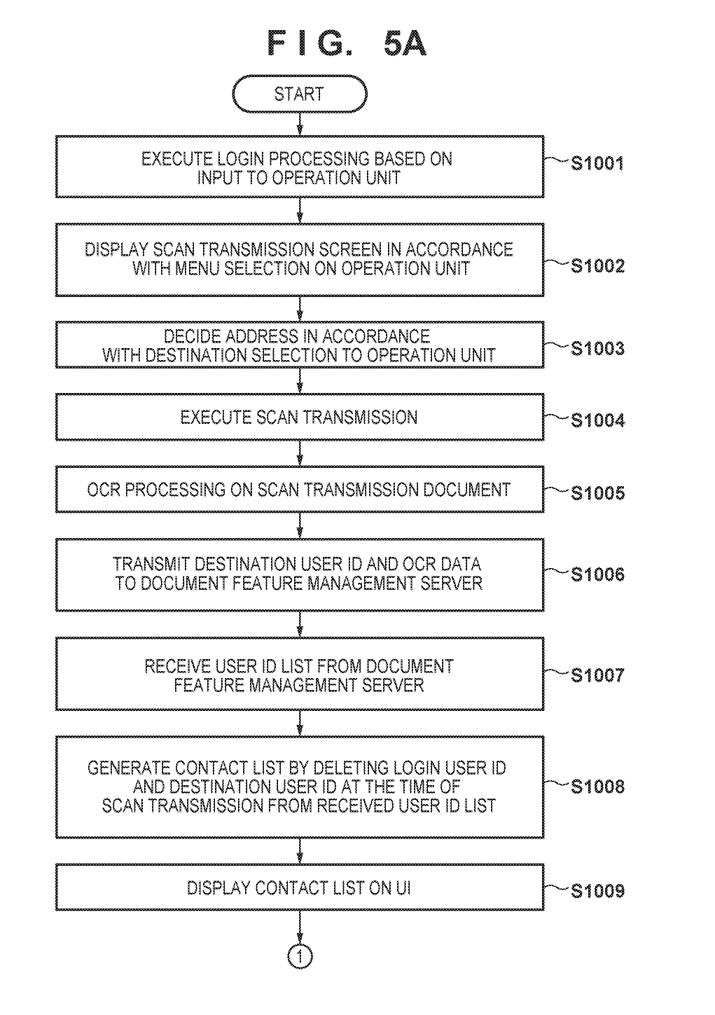

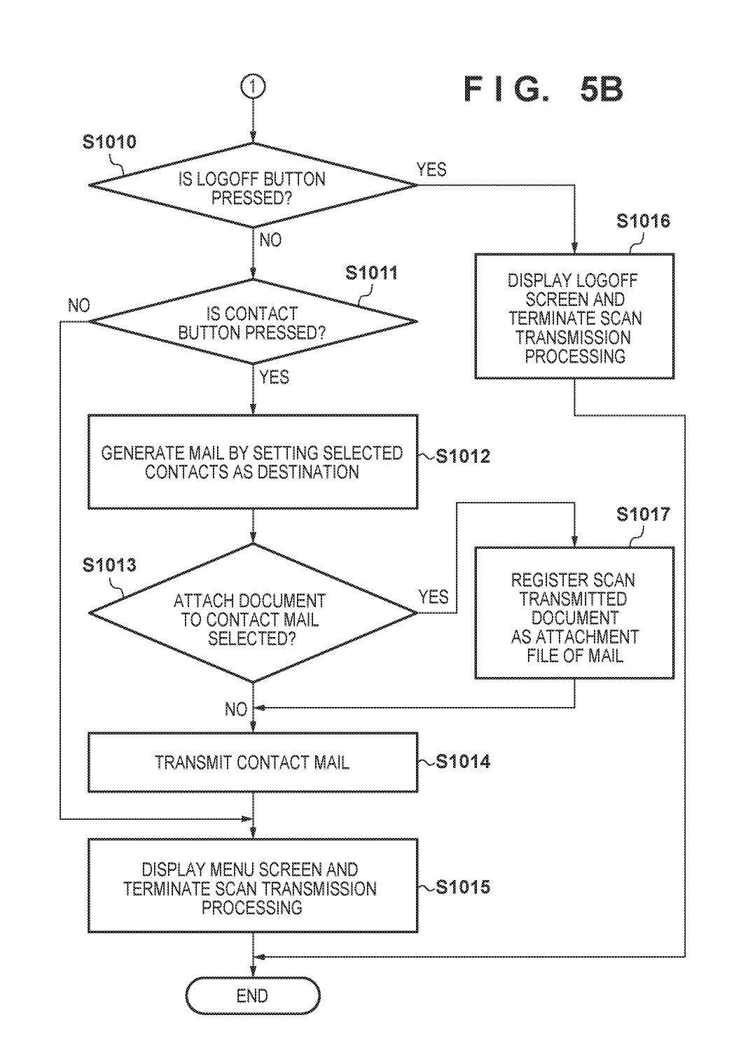

Next, with reference to FIG. 4 and FIGS. 5A and 5B, explanation is given of a processing procedure in a case in which a contact recommendation function is executed at a time of a scan transmission execution in the MFP 100. The processing explained below is realized by the CPU 201 reading the program stored in the HDD 205 into the DRAM 202 and then executing it.

Firstly, in step S1001, the CPU 201 receives a login user name and a login password from a user via the operation unit 102. Also, the CPU 201 obtains an ID of the login user by notifying the login user name and the login password to the address book server 120 via the LAN 140 to verify the validity of the user. In other words, the ID of the user is obtained here from the address book server 120 when a user authentication is performed and the authentication succeeds. The CPU 201 completes the login processing when the ID of the user is identified, and displays a function menu of the MFP 100 on the operation unit 102.

In step S1002, the CPU 201 displays a screen of a scan transmission function on the operation unit 102 in a case where the user selects the scan transmission function. In step S1003, the CPU 201 identifies a destination of a scan transmission in accordance with a user input via the operation unit 102. Furthermore, the CPU 201 queries the destination identified in the address book server 120 via the LAN 140 to obtain an ID of the destination user.

In step S1004, the CPU 201 executes a scan transmission when the user instructs an initiation of the scan transmission. Specifically, the CPU 201 reads in an original from the scanner unit 104 and stores it as image data (document data) in the DRAM 202. It transmits an electronic mail with the image data stored in the DRAM 202 as an attachment file to the identified destination.

Next, in step S1005, the CPU 201 applies OCR processing to the image data stored in the DRAM 202 at the time of the scan transmission to convert the image data into text data, and stores the text data in the

DRAM 202. In step S1006, the CPU 201 transmits to the document feature management server 110 via the LAN 140 the ID of the destination user and the text data arranged in the DRAM 202 after the OCR processing.

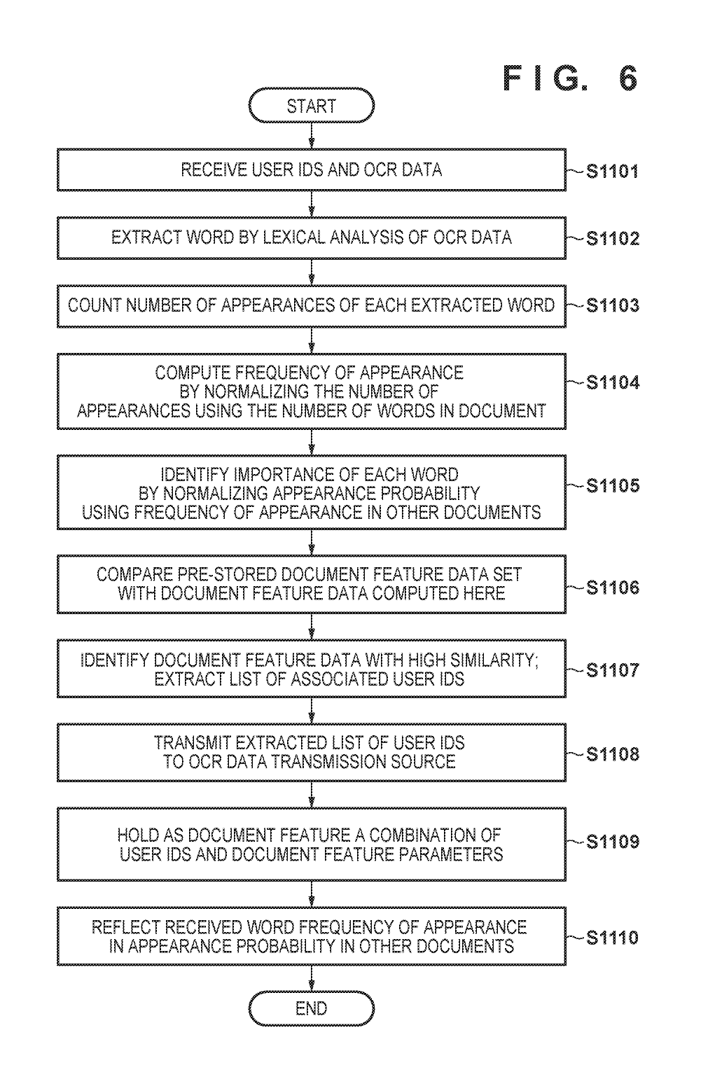

In step S1007, the CPU 201 receives a list of user IDs (a list of candidates) from the document feature management server 110 via the LAN 140. The list of candidates is a list generated by processing in the document feature management server described later using FIG. 6. In step S1008, the CPU 201 deletes the ID of the login user and the ID of the destination user at the time of the scan transmission from the received list of user IDs, to generate a list of user IDs having an interest in the scan transmission document who are neither the transmitter or the recipient at the time of the scan transmission. Furthermore, it makes a query for the user IDs via the LAN 140 to the address book server 120, to generate a contact list comprising an ID, a name, and a mail address for each user.

In step S1009, the CPU 201, functioning as a display control unit, displays an address recommendation screen 401 illustrated in FIG. 4 so that candidates can be selected. Here, the contact list obtained in step S1008 is displayed in contact list 402 of the address recommendation screen 401. Because the contact list 402 is a selectable list box, it is possible to send image data transmitted in step S1004 to all destinations, and to send to some of the destinations, in accordance with a selection of the user. Also, as illustrated in FIG. 4, a contact button 403, a close button 404, a logoff button 405, and a check-box 406 are included in the address recommendation screen 401.

In step S1010, the CPU 201 determines whether or not the logoff button 405 was pressed. If the logoff button 405 was pressed, the processing proceeds to step S1016, the CPU 201 terminates the scan transmission function by executing logoff processing, and displaying the login screen. Meanwhile, if a logoff button is not pressed, the processing proceeds to step S1011, and the CPU 201 determines whether or not the contact button 403 was pressed. If it detects that the contact button 403 was pressed, the processing proceeds to step S1012, and otherwise the processing proceeds to step S1015.

In step S1012, the CPU 201 generates mail data setting contacts selected via the address recommendation screen 401 as destinations and the login user as a return address, and the processing proceeds to step S1013. In step S1013, the CPU 201 determines whether or not a selection of an “attach document to contact mail” check-box 406 is detected. If it is detected, the processing proceeds to step S1017, otherwise the processing proceeds to step S1014. In step S1017, the CPU 201 arranges image data stored in the DRAM 202 at the time of the scan transmission in step S1004 in attachment data of the mail data, and the processing proceeds to step S1014. In other words, if the check-box 406 is not selected, only the contact mail is transmitted without attaching the image data. In such a case, the contact mail is for notifying that processing that uses the foregoing image data was executed in the MFP 100, for example.

In step S1014, the CPU 201 transmits the contact mail, and the processing proceeds to step S1015. Also, if, in step S1011, it was not detected that the contact button 403 was pressed, the CPU 201 advances the processing to step S1015 because it is the case where the close button 404 is selected. In step S1015 the CPU 201 terminates the scan transmission function by displaying the menu screen.

<Document Feature Management Server Processing Procedure>

Next, using FIG. 6, explanation is given for a processing procedure of the document feature management server 110 in a case where the contact recommendation function is executed at a time of a scan transmission execution in the MFP. This processing procedure is the same as in other embodiments because the processing procedure of the document feature management server 110 does not change even if the client is an information apparatus other than the MFP. The processing explained below is realized by the CPU 301 reading the program stored in the HDD 305 into the DRAM 302 and executing it.

In step S1101, the CPU 301 receives a list of user IDs and OCR data via the LAN 140. In step S1102, the CPU 301 extracts words by lexical analysis of the received OCR data. Next, in step S1103, the CPU 301 counts the number of appearances of each extracted word in the received OCR data.

Next, in step S1104, the CPU 301 computes a frequency of appearance for each word by normalizing the number of appearances of the words by dividing the number of appearances for each word by the total number of words included in the OCR data. In step S1105, the CPU 301 computes the importance of each word by performing normalization by dividing an appearance probability in other documents computed in advance with respect to the frequency of appearance of each word. This importance is based on a TF-IDF (Term Frequency-inverse Document Frequency) method commonly used in a method of text mining. In other words, if words that occur frequently in a particular document do not occur frequently in other documents, these words are set as words that specify the document. Furthermore, here document feature data is created in a format in which a combination of a word and an importance are stored as an array, and handled as a vector.

Next, in step S1106, the CPU 301 performs a comparison between a set of pre-stored items of document feature data and the document feature data computed here (analysis result). A similarity of the foregoing vector is used in the comparison method. Specifically, because the comparison targets are vectors, if a dot product of the vectors is taken, a scalar value with a maximum of 1.0 is obtained. The more that features of both sides are similar, the higher this numerical value becomes, and it becomes a maximum value, in other words 1.0, at the time of a match. In step S1107, the CPU 301 identifies document feature data that can be deemed to be similar from the result of the comparison. Specifically, it identifies data for which the value compared in step S1106 is greater than or equal to a predetermined threshold.

In this embodiment, an extremely high similarity is not necessary for determining whether content of studies is the same in relation to documents, and similarity is determined by being greater than or equal to 0.3 (the threshold) here. This identifying processing is processing for identifying a similar document from feature points of documents previously accumulated in the present invention. In step S1107, the CPU 301 extracts a list of user IDs in association with document feature data (parameters) determined to be similar. This extraction processing identifies document users associated with feature points of documents that are similar in the present invention.

In step S1108, the CPU 301 transmits the list of the user IDs extracted in step S1007 to the transmission source of the OCR data received in step S1101. Here, the transmitted list of user IDs is used as contacts to propose on the receiving side. In step S1109, the CPU 301 associates the document feature data computed in step S1105 with the user ID received in step S1101, adds this to a document feature data set, and uses it in the comparison processing in step S1106 the next time. Processing for adding to this data set corresponds to processing that accumulates combinations of documents, feature points, and document users, in the present invention. In step S1110, after weighting appearance probability information in other documents by a document feature set number, the CPU 301 performs multiplication with the appearance probability for each word computed in step S1104, and updates and reflects the appearance probability information in the other documents. The updated information of appearance probability in other documents is used in the normalization processing of step S1105 the next time.

As explained above, in relation to features of a document indicated by document data processed in accordance with an instruction of an authenticated user, the information processing apparatus according to the embodiment obtains from a document feature management server a list of candidates that can use the document data, and displays the list on the operation unit. Specifically, the information processing apparatus transmits to the document: feature management server content of the document and information of the authenticated user, and a list that identifies candidates is generated from information already stored in the document feature management server. With this, in the MFP 100 it is possible to execute recommending a contact at a time of a scan transmission execution, for example. The present embodiment gives an explanation in which the scan transmission function is given as an example, but it is possible to similarly perform a recommendation (proposal) of a contact and an accumulation of document feature data by associating a login user and a copy document at a time of copying, and by associating a login user and a PDL document at a time of PDL printing. In this way, by virtue of the present embodiment, when a user uses a document, it is possible to use content of the document and information of the user to present a list of candidates who can use the document while reducing a risk of a confidentiality leak.

### Second Embodiment

Below, explanation will be given for a second embodiment of the present invention. In this embodiment, explanation is given, as an example, of cooperation between the document feature management server 110 and a PC (Personal Computer) 150, which is an information processing apparatus.

<System Configuration>

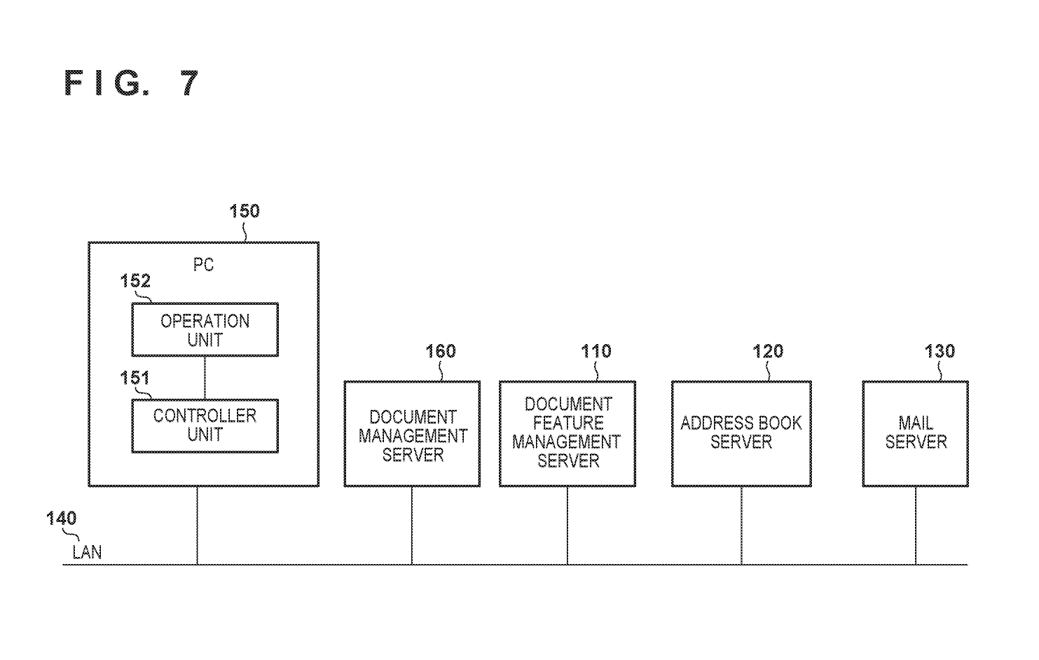

Firstly, explanation is given regarding a configuration of system according to the embodiment, with reference to FIG. 7. The system according to the embodiment comprises the PC 150, which is an information processing apparatus, a document management server 160, the document feature management server 110, the address book server 120, and the mail server 130. Each of these apparatuses is communicably connected via the LAN 140.

The PC 150 has an operation unit 152 for performing input/output with a user. The operation unit 152 is connected to a controller unit 151, and by control of the controller unit 151, executes inputting and outputting with respect to the user, as well as other application functions to be executed on the PC 150. The document management server 160 may be any server that can perform uploading and downloading of a document file via the LAN 140. Here, it is assumed to be something in which an implementation of WebDAV (Web-based Distributed Authoring and Versioning) is operating. Because the document feature management server 110, the address book server 120, the mail server 130, and the LAN 140 are similar to as in the foregoing first embodiment, explanation thereof is omitted.

<PC Control Configuration>

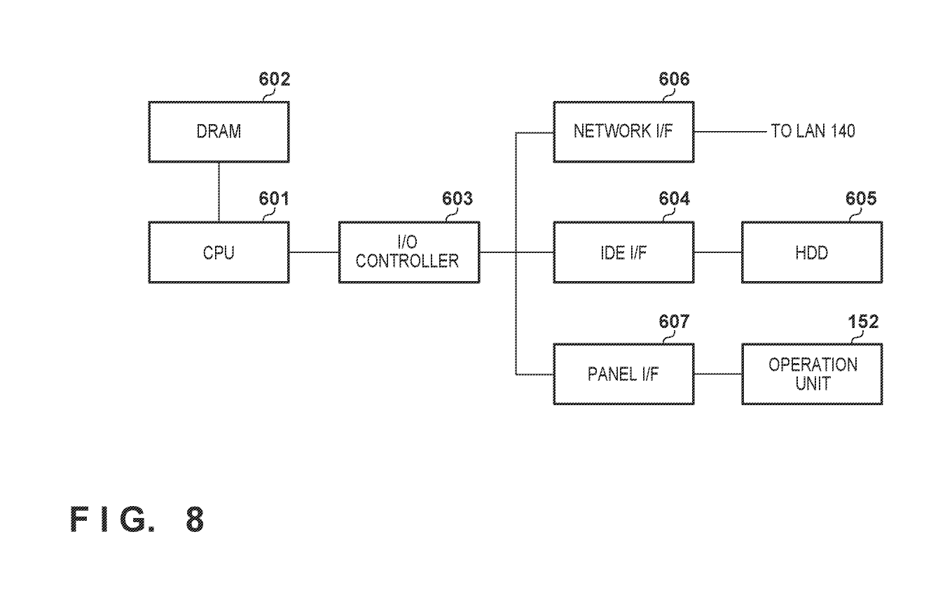

Next, with reference to FIG. 8, explanation is given for a detailed control configuration of the controller unit 151 of the PC 150. The controller unit 151 comprises a CPU 601, a DRAM 602, an I/O controller 603, an IDE I/F 604, an HDD 605, a network I/F 606, and a panel I/F 607.

The CPU 601 performs primary calculation processing in the controller unit 151. The CPU 601 is connected with the DRAM 602 via a bus. The DRAM 602 is used by the CPU 601 as a work memory for temporarily arranging data to be processed, and program data describing commands for calculation by a process of the CPU 601 calculating. The CPU 601 is connected with the I/O controller 603 via a bus. The I/O controller 603 performs input/output with respect to various devices in accordance with instructions of the CPU 601. The IDE I/F 604 is connected to the I/O controller 603, and the HDD 605 is connected to the IDE I/F 604. The CPU 601 uses the HDD 605 to persistently store programs for realizing functions of the PC, and data that is inputted. The network I/F 606 is connected to the I/O controller 603, and the CPU 601 realizes communication on the LAN 140 via the network I/F 606. The panel I/F 607 is connected to the I/O controller 603, and the CPU 601 realizes input/output with respect to a user in relation to the operation unit 152 via the panel I/F 607.

<PC Processing Procedure>

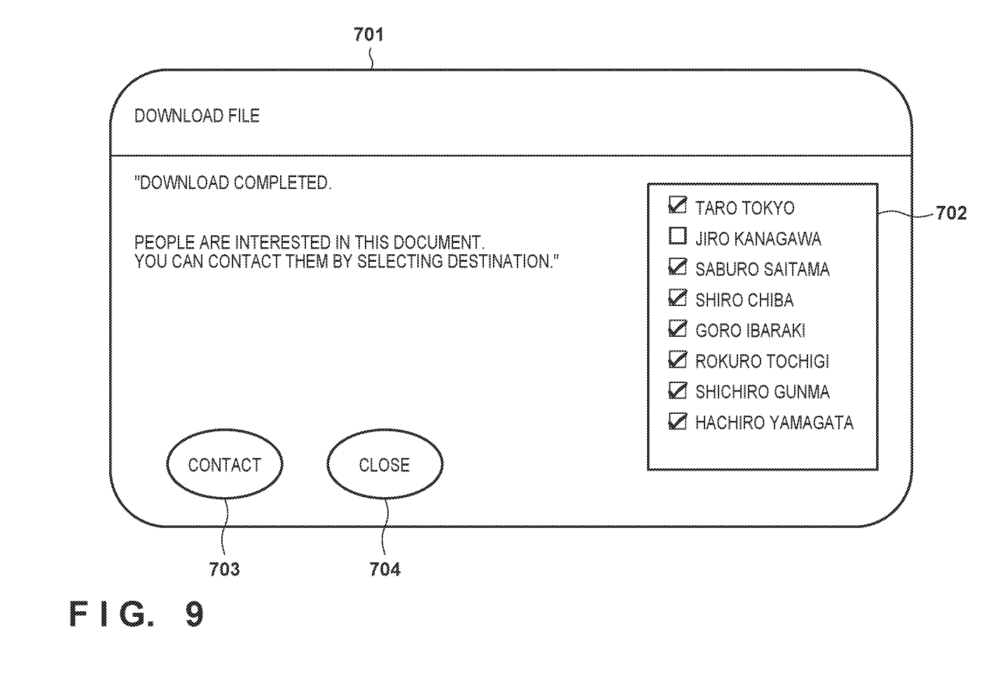

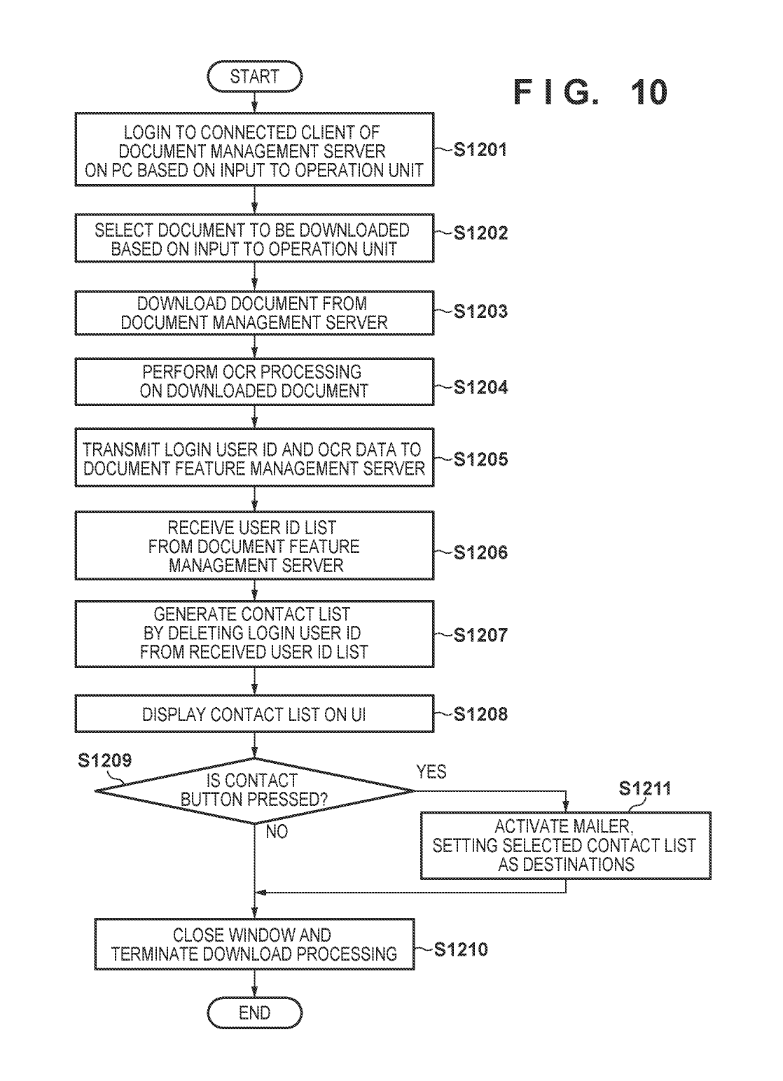

Next, using FIG. 9 and FIG. 10, explanation is given of a processing procedure in a case in which a contact recommendation function is executed at a time of a file download execution in the PC 150. The processing explained below is realized by the CPU 601 reading the program stored in the HDD 605 into the DRAM 602 and then executing it.

Firstly, in step S1201 of FIG. 10, the CPU 601 of the PC 150 receives a login user name and a login password from a user via the operation unit 152. The CPU 601 obtains an ID of the login user by notifying the login user name and the login password to the address book server 120 via the LAN 140 to verify the validity of the user. If it is possible to identify the ID of the login user, the CPU 601 transmits a request to obtain a file list to the document management server 160 via the LAN 140, and obtains a list of files saved in the document management server 160. Furthermore, upon obtaining the file list, the CPU 601 presents, via the operation unit 152, a list of document files to a user.

In step S1202, upon a user selecting a document via the operation unit 152, the CPU 601 identifies the document that is a download target. In step S1203, upon a user instructing initiation of downloading via the operation unit 152, the CPU 601 performs downloading of the document file by performing a request to obtain the file to the document management server 160 via the LAN 140. Upon completion of the downloading, the CPU 601 stores the obtained document file in the DRAM 602. In step S1204, the PC 150 performs OCR processing on the document file stored in the DRAM 602 to convert it to the text data, and stores the text data in the DRAM 602. Here, if the downloaded document file is already text data, the text data is stored in the DRAM 602 unchanged without executing the OCR processing.

In step S1205, the CPU 601 transmits to the document feature management server 110 via the LAN 140 the ID of the login user and the text data arranged in the DRAM 202 after the OCR processing. In step S1206, the CPU 601 receives a list of user IDs from the document feature management server 110 via the LAN 140 based on the information transmitted in step S1205.

In step S1207, the CPU 601 removes the ID of the login user from the list of received user IDs to create a list of IDs of users, other than oneself, who have an interest in the downloaded document. Furthermore, the CPU 601 makes a query for the user IDs via the LAN 140 to the address book server 120, to generate a contact list comprising an ID, a name, a mail address, and an affiliated department for each user. The CPU 601 removes from the contact list users for which an affiliated department is not the same as that of the login user. This removal processing is processing that is necessary if there are is an extremely large number of contacts that are recommended in a large-scale organization, and is processing that may not be necessary depending on an organization scale or a usage purpose of a connected client. In other words this processing can be optionally selected.

In step S1208, the CPU 601 displays to the user, via the operation unit 152, a recommendation screen 701 illustrated in FIG. 9. Here, a contact list 702 selectably displays on the operation unit 152 the destination list obtained in step S1207. Because the contact list 702 is a selectable list box, it is possible to send to all or to send to some in accordance with a user selection.

In step S1209, the CPU 601 detects whether a contact button 703 in the recommendation screen 701 has been pressed. If a press of the contact button. 703 is detected, the processing proceeds to step S1211, and the CPU 601 sets the contacts selected in step S1208 as destinations, sets the login user as a return address, creates mail data, and activates a mail application registered in advance in the PC 150. However, because a case in which a press of the contact button was not detected in step S1209 is the case in which the close button 704 is selected, as the processing of step S1210 the CPU 601 closes the window of the connected client, to complete the process for downloading.

As explained above, in the PC 150, which is an information processing apparatus according to the embodiment, it is possible to realize a recommendation function of a contact at a time of a document file download, and in the present embodiment it is possible to obtain a similar effect to that of the foregoing first embodiment. The present embodiment gives an explanation in which the PC 150 was the subject matter, but the technique can be similarly applied in the case of executing a connected client on an information device such as a mobile terminal.

Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Bl-ray Disc (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-114159 filed on Jun. 4, 2015, which is hereby incorporated by reference herein in its entirety.

What is claimed is:

1. An information processing apparatus comprising:
an execution unit configured to execute processing relating to document data in accordance with an instruction of a user;
an obtaining unit configured to obtain transmission destinations relating to a document feature indicated by the document data processed by the execution unit; and
a display unit configured to display to enable selection of the transmission destinations obtained by the obtaining unit.

2. The information processing apparatus according to claim 1, further comprising
a transmission unit configured to transmit, to a transmission destination selected from the transmission destinations displayed on the display unit, a contact mail indicating that processing relating to the document data has been executed by the execution unit.

3. The information processing apparatus according to claim 2, wherein
if the transmission destination is selected from the transmission destinations displayed on the display unit and transmission of the document data is instructed, the transmission unit transmits after attaching the document data to the contact mail.

4. The information processing apparatus according to claim 1, further comprising
an authentication unit configured to authenticate a user, and
an image processing unit configured to execute OCR processing of the document data that the execution unit processed,
wherein the obtaining unit obtains the transmission destinations based on information of the user authenticated by the authentication unit, and OCR data after the OCR processing is executed by the image processing unit.

5. The information processing apparatus according to claim 4, wherein the display unit deletes the user authenticated by the authentication unit from the transmission destinations obtained by the obtaining unit.

6. The information processing apparatus according to claim 1, wherein
the execution unit is a unit for executing scan processing, and
the document data is data read from an original by the scan processing.

7. The information processing apparatus according to claim 1, wherein
the execution unit is a unit for executing copy processing, and
the document data is data of a copy document copied by the copy processing.

8. The information processing apparatus according to claim 1, wherein
the execution unit is a unit for executing PDL printing, and
the document data is data of a PDL document printed by the PDL printing.

9. The information processing apparatus according to claim 1, wherein
the execution unit is a unit for executing downloading of the document data, and
the document data is data downloaded by the execution unit.

10. A method of controlling an information processing apparatus, the method comprising:
executing processing relating to document data in accordance with an instruction of a user;
obtaining transmission destinations relating to a document feature indicated by the processed document data; and
displaying to enable selection of the obtained transmission destinations.

11. A non-transitory computer-readable storage medium storing a computer program for causing a computer to execute each step in a method of controlling an information processing apparatus, the method comprising:
executing processing relating to document data in accordance with an instruction of a user;
obtaining transmission destinations relating to a document feature indicated by the processed document data; and
displaying to enable selection of the obtained transmission destinations.
